(19) United States
(12) Patent Application Publication
(10) Pub. No.: US 2023/0058913 A1
(43) Pub. Date: Feb. 23, 2023

(54) Ethylene/Octene Multi-Block Copolymer and Process for Producing Same

(71) Applicant: Dow Global Technologies LLC, Midland, MI (US)

(72) Inventors: Stacy L. Pesek, Pearland, TX (US); Jeffrey C. Munro, Bellaire, TX (US); Zhe Zhou, Lake Jackson, TX (US); Andrew J. Young, Houston, TX (US); Anthony J. Castelluccio, Lake Jackson, TX (US); Thomas Wesley Karjala, Jr., Lake Jackson, TX (US)

(21) Appl. No.: 17/788,856

(22) PCT Filed: Dec. 23, 2020
(86) PCT No.: PCT/US2020/066896

§ 371 Date: Jun. 24, 2022

Related U.S. Application Data
(60) Provisional application No. 62/954,227, filed on Dec. 27, 2019.

(51) Int. Cl. C08F 297/08

(52) U.S. Cl. CPC C08F 297/083; C08F 2410/01

(57) ABSTRACT

The present disclosure provides a process. In an embodiment, the process includes contacting ethylene and octene under polymerization conditions at a temperature greater than 125° C. with a catalyst system comprising (i) a first polymerization catalyst having the structure of Formula (III), a second polymerization catalyst having the structure of Formula (I), and (iii) a chain shuttling agent. The process includes forming an ethylene/octene multi-block copolymer having a normalized OOO triad content greater than 0.25. The present disclosure provides the resultant composition produced by the process. In an embodiment, the composition includes an ethylene/octene multi-block copolymer having a normalized OOO triad content greater than 0.25.

### BACKGROUND

Ethylene/octene multi-block copolymer provides the benefits of both the durability and high temperature resistance of high density polyethylene while maintaining key properties of elastomeric, low density polyolefin such as elastic behavior, flexibility, and processability. Ethylene/octene multi-block copolymer typically contains high density “hard” segments and low density “soft” segments. The soft segment contains higher content of comonomer which may be soft and prone to sticking. For commercial production of ethylene/octene multi-block copolymers where bulk shipment is valuable, the low density soft block is a limiting constraint for large scale production and storage of pellets. Many applications could benefit from a lower density soft block (more octene incorporation), however the existing ethylene/octene multi-block copolymer system is limited due to poor solids handling.

The art recognizes the need for an ethylene/octene multi-block copolymer with increased soft segment octene incorporation and improved solids handling performance, specifically improved (lower) unconfined yield strength.

### SUMMARY

The present disclosure provides a process. In an embodiment, the process includes contacting ethylene and octene under polymerization conditions at a temperature greater than 125° C. with a catalyst system comprising (i) a first polymerization catalyst having the structure of Formula (III), a second polymerization catalyst having the structure of Formula (I), and (iii) a chain shuttling agent. The process includes forming an ethylene/octene multi-block copolymer having a normalized OOO triad content greater than 0.25.

The present disclosure provides the resultant composition produced by the process. In an embodiment, the composition includes an ethylene/octene multi-block copolymer having a normalized OOO triad content greater than 0.25.

### BRIEF DESCRIPTION OF THE DRAWINGS

FIG. 1 is a graph showing extrapolation of the elution temperature for TGIC temperature calibration. The solid line is experimental data. The dashed line is the extrapolation of elution temperature for two isothermal steps.

FIG. 2 is a graph showing the correlation of elution peak temperature (Tp) of ethylene-octene copolymers made by single site catalysts versus octene wt %. High-Temperature Thermal Gradient Interaction Chromatography (TGIC) is measured according to the reference (Cong et al., Macromolecule, 2011, 44 (8), 3062-3072), incorporated by reference herein. Octene content is measured by ¹³C NMR as disclosed in U.S. Pat. No. 7,608,668 incorporated by reference herein.

FIG. 3 is a schematic representation of a test apparatus for funnel flow (FF). The FF test apparatus includes a steep glass funnel attached to a cylinder (4.15 inch diameter). The cylindrical section provides necessary capacity, so that a substantial amount of pellets can be tested.

FIG. 4 is a graph showing High-Temperature Thermal Gradient Interaction Chromatography (TGIC) second peak temperature (Tₚ₂) as a function of soft segment melting temperature (SS-Tm), for inventive examples and comparative samples of ethylene/octene multi-block copolymers in accordance with an embodiment of the present disclosure.

FIG. 5 is a TGIC curve showing the first peak temperature (Tₚ₁) and the second peak temperature (Tₚ₂) for inventive example 1 in accordance with an embodiment of the present disclosure.

FIG. 6 is DSC heating curve showing the soft segment melting peak for inventive example 1 in accordance with an embodiment of the present disclosure.

FIG. 7 is a graph showing soft segment melting temperature (SS-Tm) as a function of normalized OOO triad, for inventive examples and comparative samples of ethylene/octene multi-block copolymer in accordance with an embodiment of the present disclosure.

FIG. 8 is a graph showing glass transition temperature (Tg) as a function of normalized OOO triad, for inventive examples and comparative samples of ethylene/octene multi-block copolymer in accordance with an embodiment of the present disclosure.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, all parts and percents are based on weight and all test methods are current as of the filing date of this disclosure.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” is a polymer that contains more than 50 weight percent (wt %) polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably.

An “interpolymer” is a polymer prepared by the polymerization of at least two different monomers. This generic term includes copolymers, usually employed to refer to polymers prepared from two different monomers, and polymers prepared from more than two different monomers, e.g., terpolymers, tetra polymers, etc.

An “olefin-based polymer” or “polyolefin” is a polymer that contains more than 50 weight percent polymerized olefin monomer (based on total amount of polymerizable monomers), and optionally, may contain at least one comonomer. Nonlimiting examples of an olefin-based polymer include ethylene-based polymer or propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

### Test Methods

### ¹³C NMR

¹³C nuclear magnetic resonance (¹³C NMR) Samples are prepared by adding approximately 2.7 g of a 50/50 (w:w) mixture of tetrachloroethane-d₂/orthodichlorobenzene containing 0.025M chromium acetylacetonate, Cr(AcAc)₃, (or a tetrachloroethane-d₂ containing 0.025 M Cr(AcAc)₃) to 0.2 g polymer sample in a 10 mm NMR tube. Oxygen is removed from the sample by purging the tube headspace with nitrogen. The samples are then dissolved and homogenized by heating the tube and its contents to 135° C. using a heating block and a heat gun. Each dissolved sample is visually inspected to ensure homogeneity.

¹³C NMR data are collected using a 10 mm cryoprobe on either a Bruker 400 MHz or a 600 MHz spectrometer. The data is acquired using a 7.3 second pulse repetition delay, 90-degree flip angles, and inverse gated decoupling with a sample temperature of 120° C. All measurements are made with no sample spinning and in locked mode. Samples are allowed to thermally equilibrate for 7 minutes prior to data acquisition. The ¹³C NMR chemical shifts are internally referenced to the EEE triad at 30.0 ppm.

Comonomer content is determined using the assignments from reference (Liu, W.; Rinaldi, P. L.; McIntosh, L. H.; and Quirk, R. P.; Macromolecules, 34, 2001, 4757-4767) and integrated ¹³C NMR spectrum to solve the vector equation s=fM, where M is an assignment matrix, s is a row vector representation of the spectrum, and f is a mole fraction composition vector. The elements of f is taken to be triads of ethylene (E) and octene (0) with all permutations of E and O. The assignment matrix M is created with one row for each triad in f and a column for each of the integrated NMR signals. The elements of the matrix are integral values determined by reference to the assignments (Liu, W.; Rinaldi, P. L.; McIntosh, L. H.; and Quirk, R. P.; Macromolecules, 34, 2001, 4757-4767). The equation is solved by variation of the elements of f as needed to minimize the error function between s and the integrated ¹³C data for each sample. This is performed in Microsoft Excel by using the Solver function.

EOE/1000C, EOO(OOE)/1000C and OOO/1000C are measured by first setting the integral from 8-46 ppm to 1000, then measure methine peak integral around 38.2 ppm for EOE, around 35.9 ppm for EOO(OOE) and 33.7 ppm for OOO. Total O/1000C is defined as EOE/1000C+EOO(OOE)/1000C+OOO/1000C. The term “1000C” is 1000 carbon atoms, the term “/1000C” is per 1000 carbon atoms. “Percent OOO” (or “OOO %”) is defined as OOO %=100*(OOO/1000C)/(Total O/1000C). “Normalized OOO content” (Norm OOO) is defined as (OOO %)/(NMR O mol %).

Density is measured in accordance with ASTM D792, Method B. The result is recorded in grams per cubic centimeter (g/cc).

### Differential Scanning Calorimetry (DSC)

Differential Scanning calorimetry (DSC) can be used to measure the melting, crystallization, and glass transition behavior of a polymer over a wide range of temperature. For example, the TA Instruments Discovery DSC, equipped with an RCS (refrigerated cooling system) and an autosampler is used to perform this analysis. During testing, a nitrogen purge gas flow of 50 ml/min is used. Each sample is melt pressed into a thin film at about 190° C.; the melted sample is then air-cooled to room temperature (about 25° C.). A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C. and held isothermal for 5 minutes in order to remove its thermal history. Next, the sample is cooled to −90° C. at a 10° C./minute cooling rate and held isothermal at −90° C. for 5 minutes. The sample is then heated to 150° C. (this is the “second heat” ramp) at a 10° C./minute heating rate. The cooling and second heating curves are recorded.

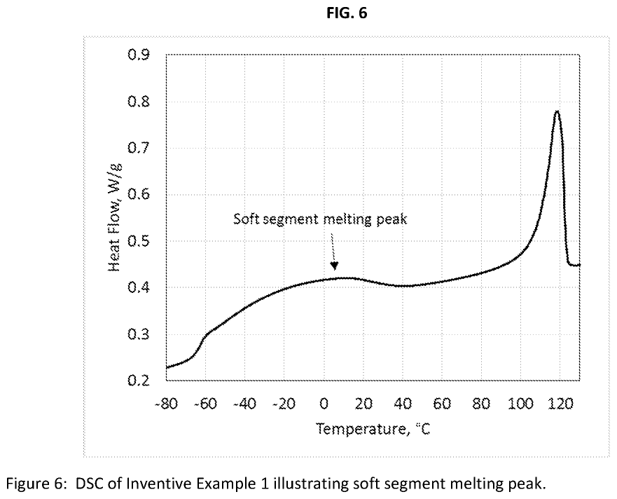

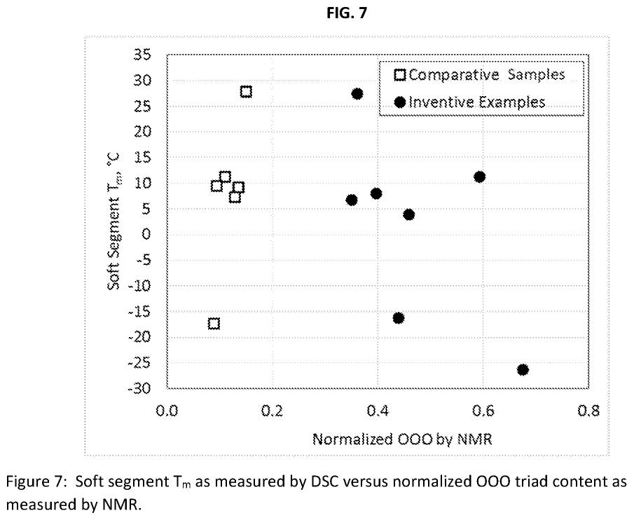

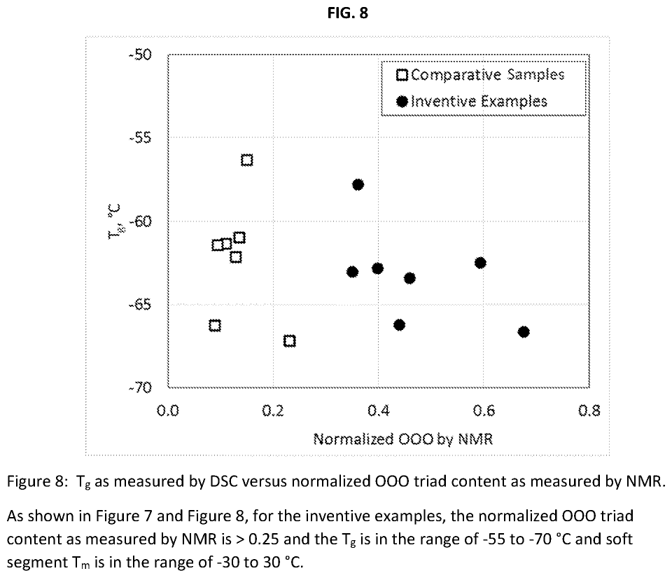

The soft segment melting temperature, SS-Tm, is determined from the DSC second heating curve. Ethylene/octene multi-block copolymers typically has two melting peaks, one melting peak associated with each of the soft segment and hard segment. The SS-Tm is associated with the lower temperature peak, as shown in FIG. 6. For some block copolymers, the peak associated with the melting of the soft segments is a small hump (or bump) over the baseline, making it difficult to assign a peak maximum. This difficulty can be overcome by converting a normal DSC profile into a weighted DSC profile using the following method. In DSC, the heat flow depends on the amount of the material melting at a certain temperature as well as on the temperature-dependent specific heat capacity. The temperature dependence of the specific heat capacity in the melting regime of linear low-density polyethylene leads to an increase in the heat of fusion with decreasing comonomer content. That is, the heat of fusion values get progressively lower as the crystallinity is reduced with increasing comonomer content. See Wild, L. Chang, S.; Shankernarayanan, M J. Improved method for compositional analysis of polyolefins by DSC. Polym. Prep 1990; 31: 270-1, which is incorporated by reference herein in its entirety. For a given point in the DSC curve (defined by its heat flow in watts per gram and temperature in degrees Celsius), by taking the ratio of the heat of fusion expected for a linear copolymer to the temperature-dependent heat of fusion (ΔH (T)), the DSC curve can be converted into a weight-dependent distribution curve. The second heating curve is baseline corrected by drawing a linear baseline between the heat flow at −30 and 135° C. The temperature-dependent heat of fusion curve can then be calculated from the summation of the integrated heat flow between two consecutive data points and then represented overall by the cumulative enthalpy curve. The expected relationship between the heat of fusion for linear ethylene/octene copolymers at a given temperature is shown by the heat of fusion versus melting temperature curve. Using random ethylene/octene copolymers, one can obtain the following relationship for the expected heat of fusion of linear copolymers, ΔH_{linear copolymer}, and melting temperature, Tₘ (in ° C.):

ΔH_{linear copolymer}(J/g)=0.0072*Tₘ²+0.3138*Tₘ+8.9767

For each integrated data point, at a given temperature, by taking a ratio of the enthalpy from the cumulative enthalpy curve to the expected heat of fusion for linear copolymers at that temperature, fractional weights can be assigned to each point of the DSC curve. The method is applicable to ethylene/octene copolymers but can be adapted to other polymers. The soft segment Tm is assigned as the location of the maximum in the enthalpy fractional weight versus temperature curve.

Glass transition temperature, Tg, is determined from the DSC second heating curve where half the sample has gained the liquid heat capacity as described in Bernhard Wunderlich, The Basis of Thermal Analysis, in Thermal Characterization of Polymeric Materials 92, 278-279 (Edith A. Turi ed., 2d ed. 1997). Baselines are drawn from below and above the glass transition region and extrapolated through the Tg region. The temperature at which the sample heat capacity is half-way between these baselines is the Tg.

Melting point, Tm, of the polymer is determined as the temperature corresponding to the maximum heat flow in the DSC heating curve.

Elastic Recovery

100% and 300% Hysteresis is determined from cyclic loading to 100% and 300% strains using ASTM D 1708 microtensile specimens with an Instron™ instrument. The sample is loaded and unloaded at 267% min⁻¹ for 3 cycles at 21° C. In the 300% strain cyclic experiment, the retractive stress at 150% strain from the first unloading cycle is recorded. Percent recovery for all experiments are calculated from the first unloading cycle using the strain at which the load returned to the base line. The percent elastic recovery is defined as:

$$\% Recovery = \frac{{ε}_{f} - {ε}_{s}}{{ε}_{f}} \times 100$$

where ε_{f} is the maximum strain used for cyclic loading and εₛ is the strain where the load returns to the baseline during the 1^{st} unloading cycle.

### Funnel Flow

The funnel flow, or “FF,” test quantifies pellet-to-pellet stickiness and the test is based on the basic concept that increased interparticle interaction (stickiness) will reduce the discharge rate out of a steep funnel. The change in discharge rate can be related to change in surface properties (i.e. stickiness) of a polymer pellet.

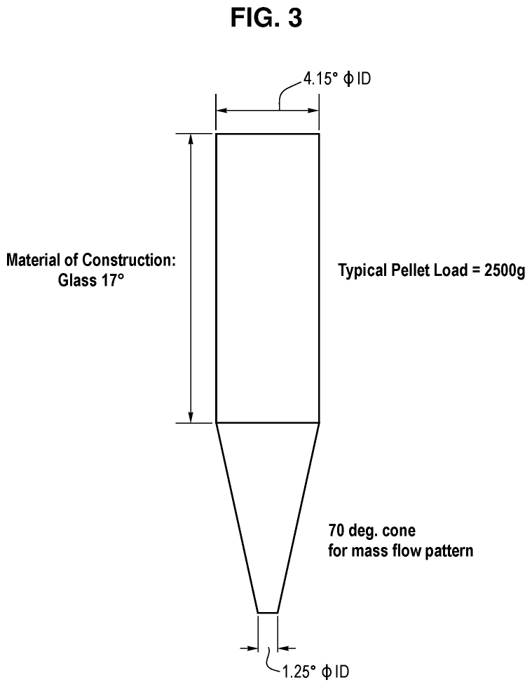

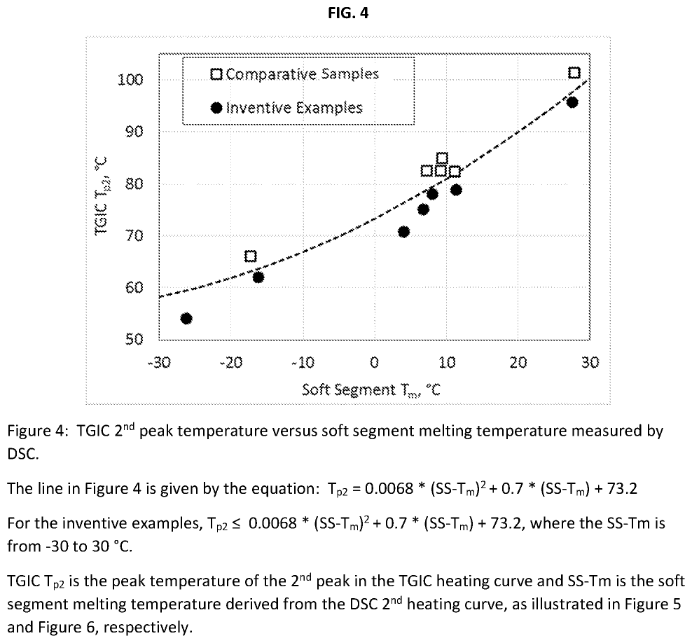

The test apparatus (see FIG. 3) consists of a steep glass funnel attached to a cylinder (4.15 inch diameter). The cylindrical section provides necessary capacity, so that substantial amount of pellets can be tested, and to avoid the problem of differentiating small values of discharge times. The test was repeated five times for statistical purposes.

The discharge rate of pellets was measured on commercial references “as received” and inventive examples (pellets) were talc coated prior to measurement. Pellets were conditioned at a predefined storage temperature, for a predetermined duration. Pellets were “thermally treated” or “aged” at 42° C. for three weeks. The conditioned pellets were cooled overnight, at 21° C., to achieve constant temperature.

As discussed above, polymer (about 2500 g; pellet form; 30±10 pellets per gram) was thermally treated in an oven, at 42° C. for three weeks. The polymer was recovered from the oven, and allowed to cool for 12 hours at 21° C. The funnel was charged with the polymer pellets (2500 g), and the time for complete discharge of the pellets from the funnel was measured, and the discharge rate was calculated using the equation below.

$$Discharge Rate or Flowability ( \frac{g}{s} ) - \frac{Amount of Pellets in Funnel ( g )}{Time taken to Discharge ( s )}$$

The funnel flow is an indicator of pellet stickiness, and is reported in grams per second (g/s). It has been determined that flowability of 120 g/s is the minimum flow rate desired to achieve acceptable handling characteristics of the polymer pellets. However, even higher rates are preferred for better handling of the polymer pellets. Higher pellet flowability values correspond to more free-flowing and less sticky pellets.

Pellet Coating with Talc

Place the pellets to be coated in a Ziploc bag. The size of the bag is such that it is roughly half filled with pellets to ensure proper mixing. Calculate the amount of coating agent (talc) needed to coat the pellets to the desired ppm level using the following equation:

weight of coating material (gm)=weight of pellets (gm)×desired coating level (ppm)/1,000,000

Weigh the amount of coating material using a 4-place decimal balance, and split into 4 equal parts. Take the 1^{st} part (¼ of the coating material) and sprinkle over the surface of the pellets in the Ziploc bag. Fill the bag with air and thoroughly mix the pellets for 30 seconds by tossing the pellets back and forth. Repeat for each of the 3 remaining portions.

High-Temperature Thermal Gradient Interaction Chromatography (TGIC).

A commercial Crystallization Elution Fractionation instrument (CEF) (Polymer Char, Spain) was used to perform the high temperature thermal gradient interaction chromatography (HT-TGIC, or TGIC) measurement (Cong, et al., Macromolecules, 2011, 44 (8), 3062-3072.). The CEF instrument is equipped with either an IR-4 detector or an IR-5 detector. Graphite has been used as the stationary phase in an HT TGIC column (Freddy, A. Van Damme et al., U.S. Pat. No. 8,476,076; Winniford et al., U.S. Pat. No. 8,318,896.). A single graphite column (250×4.6 mm) was used for the separation. Graphite is packed into a column using a dry packing technique followed by a slurry packing technique, as disclosed in European Patent No. EP 2714226B1, the contents of which are incorporated by reference herein. The experimental parameters were: top oven/transfer line/needle temperature at 150° C., dissolution temperature at 150° C., dissolution stirring setting of 2, pump stabilization time of 15 seconds, a pump flow rate for cleaning the column at 0.500 mL/m, pump flow rate of column loading at 0.300 ml/min, stabilization temperature at 150° C., stabilization time (pre-, prior to load to column) at 2.0 min, stabilization time (post-, after load to column) at 1.0 min, SF(Soluble Fraction) time at 5.0 min, cooling rate of 3.00° C./min from 150° C. to 30° C., flow rate during cooling process of 0.04 ml/min, heating rate of 2.00° C./min from 30° C. to 160° C., isothermal time at 160° C. for 10 min, elution flow rate of 0.500 mL/min, and an injection loop size of 200 microliters.

The flow rate during cooling process was adjusted according to the length of graphite column such that all polymer fractions must remain on the column at the end of the cooling cycle.

Samples were prepared by the PolymerChar autosampler at 150° C., for 120 minutes, at a concentration of 4.0 mg/ml in ODCB (defined below). Silica gel 40 (particle size 0.2˜0.5 mm, catalogue number 10181-3, EMD) was dried in a vacuum oven at 160° C., for about two hours, prior to use. 2,6-di-tert-butyl-4-methylphenol (1.6 grams, BHT, catalog number B1378-500G, Sigma-Aldrich) and the silica gel 40 (5.0 grams) were added to two liters of ortho-dichlorobenzene (ODCB, 99% anhydrous grade, Sigma-Aldrich). For the CEF instrument equipped with an autosampler with N2 purging capability, Silica gel 40 is packed into three 300×7.5 mm GPC size stainless steel columns and the Silica gel 40 columns are installed at the inlet of the pump of the CEF instrument to dry ODCB; and no BHT is added to the mobile phase. This “ODCB containing BHT and silica gel” or ODCB dried with silica gel 40 is now referred to as “ODCB.” The TGIC data was processed on a PolymerChar (Spain) “GPC One” software platform. The temperature calibration was performed with a mixture of about 4 to 6 mg Eicosane, 14.0 mg of isotactic homopolymer polypropylene (“iPP”) (polydispersity of 3.6 to 4.0, and molecular weight Mw reported as polyethylene equivalent of 150,000 to 190,000, and polydispersity (Mw/Mn) of 3.6 to 4.0, wherein the iPP DSC melting temperature was measured to be 158-159° C. (DSC method described herein below). 14.0 mg of homopolymer polyethylene HDPE (zero comonomer content, weight average molecular weight (Mw) reported as polyethylene equivalent as 115,000 to 125,000, and polydispersity of 2.5 to 2.8), in a 10 mL vial filled with 7.0 mL of ODCB. The dissolution time was 2 hours at 160° C.

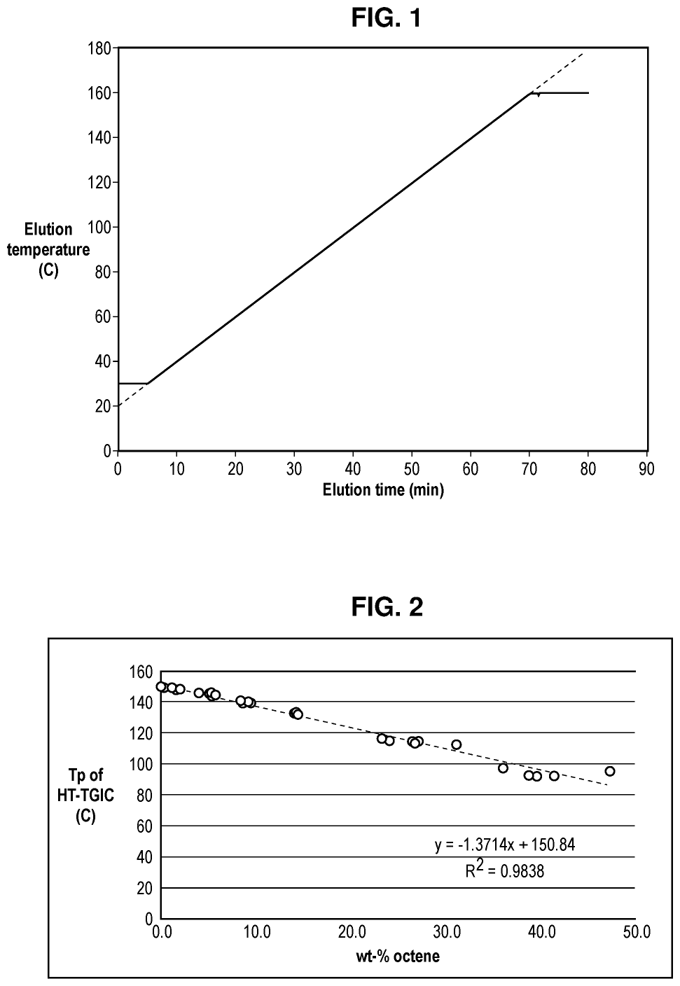

The calibration process, a solution of eicosane and HDPE, is used. For elution temperatures in the range of 30° C. to 150° C., the process consists of the following steps:
1. Extrapolate eluting temperature for each of the isothermal steps during elution according to heating rate (demonstrated in FIG. 1).
2. Calculate the delay volume. Shift the temperature (x-axis) corresponding to the IR measurement channel chromatogram (y-axis), so that the Eicosane peak maximum (y-axis) is coincident with the elution temperature at 30.0° C. The delay volume is calculated from the temperature difference (30° C.−the actual elution temperature of Eicosane peak maximum) divided by the heating rate of the method, and then multiplied by the elution flow rate.
3. Adjust each recorded elution temperature with this same delay volume adjustment.
4. Linearly scale the heating rate, such that the observed HDPE reference has an elution peak maximum temperature of 150.0° C., while the Eicosane elution peak maximum temperature remains at 30.0° C.

At least 20 ethylene octene random copolymers have been made with a single site catalyst having Mw (ethylene equivalent weight average molecular weight,) in the range from 36,000 to 150,000 and polydispersity of 2.0-2.2. The measured elution peak temperature of each ethylene octene copolymer (Tp) and octene content (wt %) of the copolymer follows the correlation specified in FIG. 2.

Data processing for polymer samples of HT-TGIC is described below.

A solvent blank (pure solvent injection) was run at the same experimental conditions as the polymer samples. Data processing for polymer samples includes: subtraction of the solvent blank for each detector channel, temperature extrapolation as described in the calibration process, compensation of temperature with the delay volume determined from the calibration process, and adjustment in elution temperature axis to the 30° C. and 160° C. range as calculated from the heating rate of the calibration.

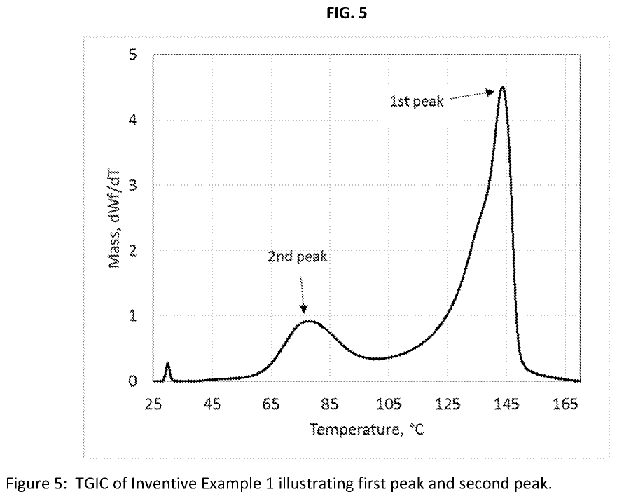

The chromatogram (measurement channel of the IR-4 detector or the IR-5 detector) was integrated with PolymerChar “GPC One” software. A straight baseline was drawn from the visible difference, when the peak falls to a flat baseline (roughly a zero value in the blank subtracted chromatogram) at high elution temperature and the minimum or flat region of detector signal on the high temperature side of the soluble fraction (SF). For some ethylene/octene multi-block copolymers of the present disclosure, the TGIC chromatogram contains three peaks as exemplified in FIG. 5. Tₚ₁ is elution temperature corresponding the peak maximum for the highest temperature elution peak. Tₚ₂ is the elution temperature corresponding to the peak maximum for the second highest temperature elution peak.

DSC method used to measure melting temperature of homopolymer polypropylene specified in HT-TGIC.

Melting point is determined using a differential scanning calorimeter (DSC). The temperature at the maximum heat flow rate with respect to a linear baseline was used as the melting point. The linear baseline was constructed from the beginning of the melting (above the glass transition temperature) and to the end of the melting. The temperature was raised from room temperature to 200° C. at 10° C./min, maintained at 200° C. for 5 min, decreased to 0° C. at 10° C./min, maintained at 0° C. for 5 min and then the temperature was raised from 0° C. to 200° C. at 10° C./min, and the data are taken from this second heating cycle.

### Triple Detector GPC (TD-GPC)

The chromatographic system for the triple detector gel permeation chromatography (TD-GPC) consisted of a PolymerChar GPC-IR (Valencia, Spain) high temperature GPC chromatograph equipped with an internal IR5 infra-red detector (IR5). The autosampler oven compartment was set at 160° C. and the column compartment was set 150° C. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1)

where M is the molecular weight, A has a value of 0.4315 and B is equal to 1.0

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{R {V}_{Peak Max}}{Peak Width at \frac{1}{2} height} )}^{2} \qquad ( EQ 2 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 4 )$$

$${Mn}_{( GPC )} = \frac{{\sum }^{i} {IR}_{i}}{{\sum }^{i} ( {IR}_{i} / {M}_{{polyethylene}_{i}} )} \qquad ( EQ 5 )$$

$${Mz}_{( GPC )} = \frac{{\sum }^{i} ( {IR}_{i} ⋆ {M}_{{polyethylene}_{i}}^{2} )}{{\sum }^{i} ( {IR}_{i} ⋆ {M}_{{polyethylene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

Flowrate(effective)=Flowrate(nominal)*(RV(FM Calibrated)/RV(FM Sample)) (EQ7)

Melt index (MI) (12) in g/10 min is measured in accordance with ASTM D1238 (190° C./2.16 kg).

### Unconfined Yield Strength (Blocking Test)

A specific blocking test is conducted on Inventive Examples (IE) 1, 2, and 4 and comparative samples (CS) CS B (INFUSE 9507), CS D (INFUSE 9107) and CS G (INFUSE 9817) to assess their anti-massing behaviors. The blocking test is performed according to the following procedure to measure the strength of pellet mass that has been consolidated at a known stress level and temperature for a pre-determined duration. A cylinder with two-inch diameter made up of two halves held together by a hose clamp is used. A thin Teflon sheet is inserted in the cell to line the cylinder wall, thereby minimizing wall friction. The amount of 60-150 grams of sample of the pellets is poured into the cylinder. The side walls of the cylinder are tapped gently during loading to settle the solids. A two-inch TEFLON® circular sheet is placed on the weight load. Test loads, temperature, and test duration are set to simulate relatively hard transportation or storage conditions. A weight load is placed on the sheet and the cylinder is placed in an oven at 37° C., for a prescribed interval. A 4.5 pound load is used to simulate a pressure of 195 lbf/ft². After the test interval, the load is then removed and the cylinder is allowed to cool at ambient conditions for at least 12 hours. The sample is then removed from the cylinder. The unconfined yield strength (UYS) is measured using an INSTRON® tensile machine in compression mode with results reported in pounds per square foot (lb/ft²).

If the pellets in the consolidated sample were totally free-flowing, the pellets did not hold the form of a cylinder, and will simply collect into a pile. If the consolidated mass of pellets does hold the form of a cylinder, an INSTRON machine was used to measure the maximum force required to crush the cylinder. The consolidated pellets were crushed using an INSTRON frame, to measure the maximum force required to break the “cylinder form” of the consolidated pellets. The consolidated pellets were positioned in the INSTRON in the vertical direction—longer dimension is the vertical direction. A constant strain rate of 2 mm/min (room temp.) was used for this test. To ensure data consistency, each composition (coated pellets) was measured twice, and the average reported.

The unconfined yield strength (UYS) was calculated as follows:

UYS (lb/ft²)=Peak force/cross-section area of cylinder.

The UYS is an indication of blocking force (the greater the unconfined yield strength, the greater the blocking force). A zero value corresponds to free-flowing pellets.

### XRF

X-ray fluorescence (XRF) was performed using Spectro-Asoma (Marble Falls, Tex.) Phoenix energy dispersive XRF spectrometer. The spectrometer was equipped with a Mo anode X-ray tube, 30 kV power supply, Mo (2 mil thick) tube filter, an atmosphere neon sealed gas proportional detector with a 1 mil thick Be window, and version 220 of the operating software. The spectrometer was used to obtain Zn Kα characteristic x-ray intensities and x-ray tube backscattered intensities for samples and standards. The operating conditions used in the Phoenix method validation are listed in Table A below. The ethylene/octene multi-block copolymer pellets were poured into XRF sample cups obtained from Chemplex Industries, INC. (catalog #1730) fit with polypropylene film (catalog #436). The cups were filled with pellets, but not overfilled so that pellets are above the top of the cup. The film was secured to the cup with the provided rings and the pellets tapped down on a flat surface covered with clean lint-free paper towel. The data was analyzed using a calibration developed based on ICP and XRF in Analytical Sciences. The reported Zn concentration values (in parts per million, “ppm”) were within +/−10%.

TABLE A

| | Tube Set-up: | Electronic Window | Count Time |
|---|---|---|---|
| Element | voltage, current | Low-High (keV) | (sec) |
| Zn | 25 kV, 60 mA | 7.0-9.14 | 100 |
| Mo - backscatter | 25 kV, 60 mA | 12.0-197.0 | 100 |

### DETAILED DESCRIPTION

The present disclosure provides a process. In an embodiment, a process is provided and includes contacting ethylene and octene under polymerization conditions at a temperature greater than 125° C. with a catalyst system. The catalyst system includes (i) a first polymerization catalyst and (ii) a second polymerization catalyst, and (iii) a chain shuttling agent. The first polymerization catalyst has the structure of Formula (III)

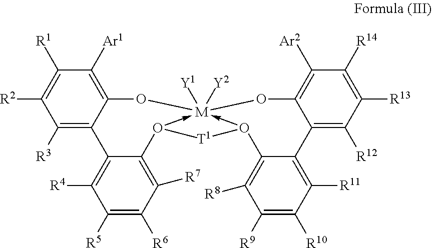

wherein

M is titanium, zirconium, or hafnium;

each Y¹ and Y² is independently selected from the group consisting of (C₁-C₄₀)hydrocarbyl, (C₁-C₄₀)trihydrocarbylsilylhydrocarbyl, halogen, alkoxide, or amine, or two Y groups together are a divalent hydrocarbylene, hydrocarbadiyl or trihydrocarbylsilyl group;

each Ar¹ and Ar² independently is selected from the group consisting of (C₆-C₄₀)aryl, substituted (C₆-C₄₀)aryl, (C₃-C₄₀)heteroaryl, and substituted (C₃-C₄₀)heteroaryl;

T¹ independently at each occurrence is a saturated C₂-C₄ alkyl that forms a bridge between the two oxygen atoms to which T¹ is bonded; and

each R¹, R², R³, R⁴, R⁵, R⁶, R⁷, R⁸, R⁹, R¹⁰, R¹¹, R¹², R¹³, and R¹⁴ independently is selected from the group consisting of hydrogen, a halogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, (C₆-C₄₀)aryl, substituted (C₆-C₄₀)aryl, (C₃-C₄₀)heteroaryl, and substituted (C₃-C₄₀)heteroaryl, and nitro (NO₂).

The second polymerization catalyst (ii) has the structure of Formula (I)

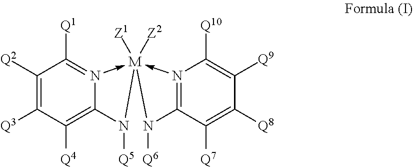

wherein

M is titanium, zirconium, or hafnium,

each Z¹ and Z² is independently selected from the group consisting of (C₁-C₄₀)hydrocarbyl, (C₁-C₄₀)trihydrocarbylsilylhydrocarbyl, halogen, alkoxide, or amine, or two Z groups together are a divalent hydrocarbylene, hydrocarbadiyl or trihydrocarbylsilyl group;

each Q¹ and Q¹⁰ independently is selected from the group consisting of (C₆-C₄₀)aryl, substituted (C₆-C₄₀)aryl, (C₃-C₄₀)heteroaryl, and substituted (C₃-C₄₀)heteroaryl;

each Q², Q³, Q⁴, Q⁷, Q⁸ and Q⁹ independently is selected from the group consisting of hydrogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, halogen, and nitro (NO₂);

each Q⁵ and Q⁶ independently is selected from the group consisting of (C₁-C₄₀)alkyl, substituted (C₁-C₄₀)alkyl, and [(Si)₁−(C+Si)₄₀] substituted organosilyl;

each N independently is nitrogen;

optionally, two or more of the Q¹⁻⁵ groups combine together to form a ring structure, with such ring structure having from 5 to 16 atoms in the ring excluding any hydrogen atoms; and

optionally, two or more of the Q⁶⁻¹⁰ groups can combine together to form a ring structure, with such ring structure having from 5 to 16 atoms in the ring excluding any hydrogen atoms.

The catalyst system also includes the chain shuttling agent (iii). The process includes forming an ethylene/octene multi-block copolymer having a normalized OOO triad content greater than 0.25.

The process includes contacting ethylene and octene under polymerization conditions at a temperature greater than 125° C. with a catalyst system. The term “polymerization conditions,” as used herein refers to process parameters under which ethylene and octene are copolymerized in the presence of a catalyst system. Polymerization conditions include, for example, polymerization reactor conditions (reactor type), reactor pressure, reactor temperature, concentrations of reagents and polymer, solvent, carrier, residence time and distribution, influencing the molecular weight distribution and polymer structure. The term polymerization conditions, as used herein, includes a polymerization temperature greater than 125° C.

In an embodiment, the polymerization conditions includes a polymerization temperature from 130° C. to 170° C., or from 130° C. to 160° C., or from 140° C. to 150° C.

The process includes contacting ethylene and octene under polymerization conditions at a temperature greater than 125° C. with a catalyst system. The catalyst system includes (i) a first polymerization catalyst of Formula (III) (above), (ii) a second polymerization catalyst of Formula (I) (above), and (iii) a chain shuttling agent.

The catalyst system includes a chain shuttling agent. A “chain shuttling agent,” as used herein, refers to a compound that is capable of causing polymeryl transfer between various active catalyst sites under the polymerization conditions. That is, transfer of a polymer fragment occurs both to and from an active catalyst site in a facile and reversible manner. In contrast to a shuttling agent or chain shuttling agent, an agent that acts merely as a “chain transfer agent,” such as some main-group alkyl compounds, may exchange, for example, an alkyl group on the chain transfer agent with the growing polymer chain on the catalyst, which generally results in termination of the polymer chain growth. In this event, the main-group center may act as a repository for a dead polymer chain, rather than engaging in reversible transfer with a catalyst site in the manner in which a chain shuttling agent does. Desirably, the intermediate formed between the chain shuttling agent and the polymeryl chain is not sufficiently stable relative to exchange between this intermediate and any other growing polymeryl chain, such that chain termination is relatively rare.

The process includes forming an ethylene/octene multi-block copolymer having a normalized OOO triad content greater than 0.25. The term “ethylene/octene multi-block copolymer” is a copolymer consisting of ethylene and octene comonomer in polymerized form, the polymer characterized by multiple blocks or segments of two polymerized monomer units (i.e., ethylene and octene) differing in chemical or physical properties, the blocks joined (or covalently bonded) in a linear manner, that is, a polymer comprising chemically differentiated units which are joined end-to-end with respect to polymerized ethylenic functionality. The ethylene/octene multi-block copolymer includes block copolymer with two blocks (di-block) and more than two blocks (multi-block). The ethylene/octene multi-block copolymer is void of, or otherwise excludes, styrene (i.e., is styrene-free), and/or vinyl aromatic monomer, and/or conjugated diene. When referring to amounts of “ethylene” or “octene,” or “comonomer” in the copolymer, it is understood that this refers to polymerized units thereof. The ethylene/octene multi-block copolymer can be represented by the following formula: (AB)n; where n is at least 1, preferably an integer greater than 1, such as 2, 3, 4, 5, 10, 15, 20, 30, 40, 50, 60, 70, 80, 90, 100, or higher, “A” represents a hard block or segment, and “B” represents a soft block or segment. The As and Bs are linked, or covalently bonded, in a substantially linear fashion, or in a linear manner, as opposed to a substantially branched or substantially star-shaped fashion. In other embodiments, A blocks and B blocks are randomly distributed along the polymer chain. In other words, the block copolymers usually do not have a structure as follows: AAA-AA-BBB-BB. In an embodiment, the ethylene/octene multi-block copolymer does not have a third type of block, which comprises different comonomer(s). In another embodiment, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

Ethylene comprises the majority mole fraction of the whole ethylene/octene multi-block copolymer. Ethylene comprises at least 50 mole % (mol %) of the whole ethylene/octene multi-block copolymer. In an embodiment, the ethylene/octene multi-block copolymer contains from 50 mol %, or 60 mol %, or 65 mol % to 80 mol %, or 85 mol %, or 90 mol %, or 95 mol % ethylene and a reciprocal amount of octene, or from 5 mol %, or 10 mol %, or 15 mol %, or 20 mol % to 35 mol %, or 40 mol %, or less than 50 mol % octene based on the total moles of the ethylene/octene multi-block copolymer. In a further embodiment, the ethylene/octene multi-block copolymer contains from 5 mol % to 30 mol % octene (and 95 mol % to 70 mol % ethylene), or from 10 mol % to 25 mol % octene (and from 90 mol % to 75 mol % ethylene).

The ethylene/octene multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of octene) is greater than 5 wt %, or greater than 8 wt %, or greater than 10 wt %, or greater than 15 wt %, based on the weight of the polymer. In an embodiment, the comonomer content in the soft segments is greater than 20 wt %, or greater than 25 wt %, or greater than 30 wt %, or greater than 35 wt %, or greater than 40 wt %, or greater than 45 wt %, or greater than 50 wt %, or greater than 60 wt % and can be up to 100 wt %.

The soft segments can be present in the ethylene/octene multi-block copolymer from 1 wt %, or 5 wt %, or 10 wt %, or 15 wt %, or 20 wt %, or 25 wt %, or 30 wt %, or 35 wt %, or 40 wt %, or 45 wt % to 55 wt %, or 60 wt %, or 65 wt %, or 70 wt %, or 75 wt %, or 80 wt %, or 85 wt %, or 90 wt %, or 95 wt %, or 99 wt % of the total weight of the ethylene/octene multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, the disclosure of which is incorporated by reference herein in its entirety. In particular, hard and soft segment weight percentages and soft segment melting temperature, SS-Tm, may be determined as described in column 57 to column 63 of U.S. Pat. No. 7,608,668, incorporated herein by reference.

The ethylene/octene multi-block copolymer comprises two or more chemically distinct regions or segments (referred to as “blocks”) joined (or covalently bonded) in a linear manner, that is, it contains chemically differentiated units which are joined end-to-end with respect to polymerized ethylenic functionality, rather than in pendent or grafted fashion. The blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/octene multi-block copolymer is characterized by unique distributions of both polymer polydispersity (PDI or Mw/Mn or MWD), polydisperse block length distribution, and/or polydisperse block number distribution, due, in an embodiment, to the effect of the shuttling agent(s) in combination with multiple catalysts used in their preparation.

In an embodiment, the ethylene/octene multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/octene multi-block copolymer possesses Mw/Mn from 1.0 to 3.5, or from 1.3 to 3, or from 1.4 to 2.5, or from 1.4 to 2.

In addition, the ethylene/octene multi-block copolymer possesses a PDI (or Mw/Mn) fitting a Schultz-Flory distribution rather than a Poisson distribution. The present ethylene/octene multi-block copolymer has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phys. (1997) 107 (21), pp. 9234-9238.

In an embodiment, the present ethylene/octene multi-block copolymer possesses a most probable distribution of block lengths.

The process forms an ethylene/octene multi-block copolymer having a normalized OOO triad content greater than 0.25.

In an embodiment, the process includes forming an ethylene/octene multi-block copolymer having a normalized OOO content from 0.30 to 0.75, or from 0.30 to 0.70, or from 0.35 to 0.70.

In an embodiment, the process includes contacting ethylene and octene under polymerization conditions at a temperature from 130° C. to 170° with a catalyst system. The catalyst system includes (i) a first polymerization catalyst that is hafnium, [[2′,2′″-[1,4-butanediylbis(oxy-κO)]bis[3-(9H-carbazol-9-yl)-5-(1,1-dimethylnonyl)-5′-fluoro[1,1′-biphenyl]-2-olato-κO]](2-)]dimethyl- and having the structure of catalyst 1

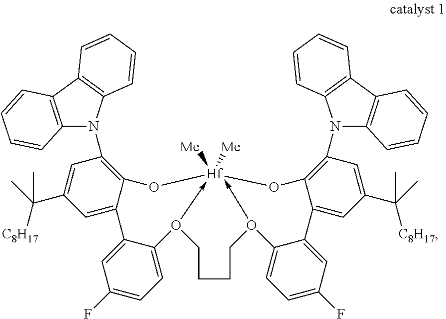

(ii) a second polymerization catalyst that is hafnium, dimethylbis[N-(2-methylpropyl)-6-(2,4,6-trimethylphenyl)-2-pyridinaminato-κN1, κN2], and has the structure of catalyst 2

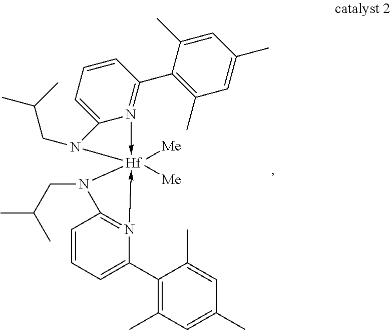

and

(iii) a chain shuttling agent that is diethyl zinc. The process includes forming an ethylene/octene multi-block copolymer having hard segments and soft segments. The soft segments have a soft segment melting temperature (SS-Tm) from −30° C. to 35° C., or from −30° C. to 30° C., the ethylene/octene multi-block copolymer having a first TGIC peak temperature (Tₚ₁) and a second TGIC peak temperature (Tₚ₂) wherein Tₚ₂ fulfills Equation (A)

Tₚ₂≤0.0068×(SS-Tm)²+0.07×(SS-Tm)+73.2. Equation (A)

The present disclosure provides a composition formed from the previously-described polymerization process. In an embodiment, the composition includes an ethylene/octene multi-block copolymer having a normalized OOO triad content greater than 0.25.

In an embodiment, the composition includes an ethylene/octene multi-block copolymer having a normalized OOO content from 0.30 to 0.75, or from 0.30 to 0.70, or from 0.35 to 0.70.

In an embodiment, the ethylene/octene multi-block copolymer of the composition includes from 10 mol % to 30 mol % of octene and a reciprocal amount of ethylene, or from 90 mol % to 70 mol % ethylene, based on total moles of the ethylene/octene multi-block copolymer.

In an embodiment, the ethylene/octene multi-block copolymer of the composition has hard segments and soft segments, the soft segments having a soft segment melting temperature (SS-Tm) from −30° C. to 35° C., or from −30° C. to 30° C. The ethylene/octene multi-block copolymer has a first TGIC peak temperature (Tₚ₁) and a second TGIC peak temperature (Tₚ₂) wherein Tₚ₂ fulfills Equation (A)

Tₚ₂≤0.0068×(SS-Tm)²+0.07×(SS-Tm)+73.2. Equation (A)

In an embodiment, the ethylene/octene multi-block copolymer of the composition fulfills Equation (A) and has a Tₚ₁ from 125° C. to 150° C. and a Tₚ₂ from 54° C. to 96° C., or from 68° C. to 90° C.

In an embodiment, the ethylene/octene multi-block copolymer ethylene/octene multi-block copolymer has a glass transition temperature (Tg) from −70° C. to −55° C., or from −67° C. to −57° C.

In an embodiment, the ethylene/octene multi-block copolymer of the composition has a density from 0.855 g/cc to 0.890 g/cc.

In an embodiment, the ethylene/octene multi-block copolymer of the composition has a Tm from 115° C. to 125° C., or from 118° C. to 123° C.

In an embodiment, the ethylene/octene copolymer of the composition has a melt index (I2) from 0.1 g/10 min to 35.0 g/10 min, or from 0.5 g/10 min to 32 g/10 min, or from 1.0 to 17 g/10 min.

In an embodiment, the ethylene/octene multi-block copolymer of the composition has an elastic recovery (Re) from 50%, or 60% to 70%, or 80%, or 90%, at 300% min⁻¹ deformation rate at 21° C.

In an embodiment, the ethylene/octene multi-block copolymer of the composition has a polydisperse distribution of blocks and a polydisperse distribution of block sizes.

In an embodiment, the ethylene/octene multi-block copolymer of the composition has an unconfined yield strength (UYS) from 0 lb/ft² to less than 200 lb/ft² at 21° C. after two months. In a further embodiment, the ethylene/octene multi-block copolymer of the composition has an unconfined yield strength (UYS) at 21° C. from 0 lb/ft² to less than 200 lb/ft² after two months, or from 0 lb/ft² to less than 100 lb/ft² after two months, or from 0 lb/ft² to less than 50 lb/ft² after two months, or from 0 lb/ft² to less than 10 lb/ft² after two months, or from 0 lb/ft² to less than 5 lb/ft² after two months, or from greater than 0 to less than 5 lb/ft² after two months.

In an embodiment the ethylene/octene multi-block copolymer of the composition has an unconfined yield strength (UYS) from 0 lb/ft² to less than 73 lb/ft² at 0° C. after two months. In a further embodiment, the ethylene/octene multi-block copolymer of the composition has an unconfined yield strength (UYS) at 0° C. from 0 lb/ft² to less than 54 lb/ft² after two months, or an unconfined yield strength (UYS) at 0° C. of 0 lb/ft² after two months.

In an embodiment, the ethylene/octene multi-block copolymer of the composition has a funnel flow from greater than 150 g/s to 200 g/s after 6 weeks.

In an embodiment, the ethylene/octene multi-block copolymer of the composition consists only of ethylene and octene comonomer and has one, some, or all of the following properties:
(i) a normalized OOO triad value from 0.35 to 0.70; and/or
(ii) from 10 mol % to 30 mol % octene and from 90 mol % to 70 mol % ethylene; and/or
(iii) a SS-Tm from −30° C. to 35° C., or from −30° C. to 30° C. wherein Tₚ₂≤0.0068×(SS-Tm)²+0.07×(SS-Tm)+73.2; and/or
(iv) a Tₚ₁ from 125° C. to 150° C. and a Tₚ₂ from 54° C. to 96° C., or from 68° C. to 90° C.; and/or
(v) a Tg from −70° C. to −55° C.; and/or
(vi) a density from 0.855 g/cc to 0.890 g/cc; and/or
(vii) a Tm from 115° C. to 125° C.; and/or
(viii) a melt index (I2) from 0.1 g/10 min to 20.0 g/10 min; and/or
(ix) an elastic recovery (Re) from 50% to 90%; and/or
(x) a Mw/Mn from 1.7 to 3.5; and/or
(xi) a polydisperse distribution of blocks and a polydisperse distribution of block sizes; and/or
(xii) an unconfined yield strength (UYS) at 21° C. from 0 lb/ft² to less than 5 lb/ft² after two months; and/or
(xiii) a funnel flow from greater than 150 to 200 g/s.

The inventive ethylene/octene multi-block copolymers described herein are useful for many applications. Due to the improved handling of pellets and lower tendency of the pellets to adhere to themselves (stickiness), the present ethylene/octene multi-block copolymers disclosed herein are beneficial to film applications, such as cast film for elastic films. The improved tack enables lower overall density, increased soft segment comonomer content, and/or higher melt flow products to be commercialized, which provide better elastic hysteresis and retractive behavior in film, such as cast film for example.

The inventive ethylene/octene multi-block copolymers described herein are also useful in foam applications, such as for footwear midsole foam applications. Sole foams made from the present inventive ethylene/octene multi-block copolymers provide athletic shoes with improved softness and improved rebound from the soft segment component of the inventive ethylene/octene multi-block copolymers.

By way of example, and not limitation, some embodiments of the present disclosure are described in detail in the following examples.

### EXAMPLES

Table 1 below provides catalysts, co-catalysts, and chain shuttling agent used to prepare Comparative Sample (CS) A and Inventive Examples (IE) 1-7.

TABLE 1
Materials

| | |
|---|---|
| 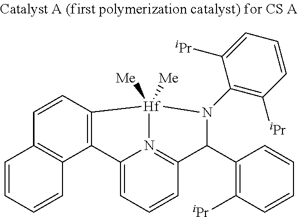 | Hafnium, [N-[2,6-bis(1-methylethyl)phenyl]-α-[2-(l- methylethyl)phenyl]-6-(1-naphthalenyl-κC2)-2- pyridinemethanaminato(2-)-κN1, κN2]dimethyl- |
| 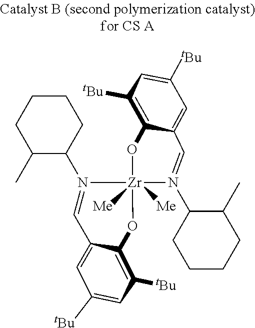 | Zirconium, bis[2,4-bis(1,1-dimethylethyl)-6-[[(2- methylcyclohexyl)imino-κN]methyl]phenolato- κO]dimethyl- |
| 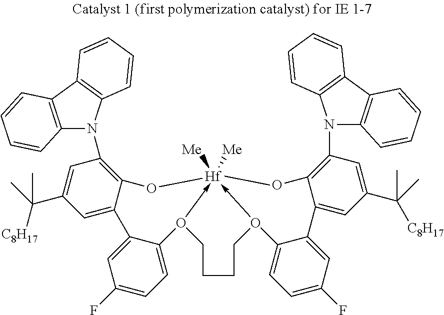 | Hafnium, [[2′,2′′′-[1,4-butanediylbis(oxy-κO)]bis[3-(9H- carbazol-9-yl)-5-(1,1-dimethylnonyl)-5′-fluoro[1,1′- biphenyl]-2-olato-κO]](2-)]dimethyl- |
| 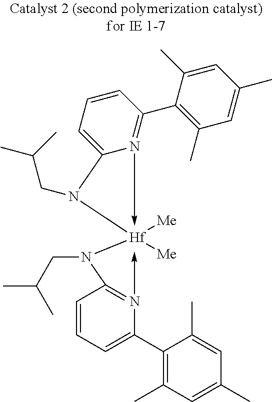 | Hafnium, dimethylbis[N-(2-methylpropyl)-6-(2,4,6- trimethylphenyl)-2-pyridinaminato-κN1, κN2]- |
| Cocatalyst 3 - all samples | A mixture of methyldi(C₁₄₋₁₈ alkyl)ammonium salts |
| | of tetrakis-(pentafluorophenyl)borate, prepared by |
| | reaction of a long chain trialkylamine (ARMEEN |
| | M2HT, available from Akzo-Nobel, Inc.), HCl and |
| | Li[B(C₆F₅)₄], cocatalyst 3 available from Boulder |
| | Scientific |
| Cocatalyst 4 - all samples | iso-butyl, methyl, branched, cyclic and linear |
| | modified methyl aluminosiloxane (MMAO), |
| | available from AkzoNobel |
| Chain Shuttling Agent - all samples | diethylzinc |

### Polymerization of CS A and IE 1-7

All raw materials (ethylene and octene) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressurized to above reaction pressure. All reaction feed flows are measured with mass flow meters and independently controlled with computer automated control systems.

The continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the reactor (solvent, monomer, comonomer, and hydrogen) is temperature controlled to maintain a single solution phase by passing the feed stream through a heat exchanger. The total fresh feed to the polymerization reactor is injected into the reactor at two locations with approximately equal reactor volumes between each injection location. The fresh feed is controlled with each injector receiving half of the total fresh feed mass flow. The catalyst components are injected into the polymerization reactor through specially designed injection stingers. The first polymerization catalyst component feed (catalyst A and catalyst 1 from Table 1) is computer controlled to maintain the reactor monomer conversion at the specified target. The molar ratio of the second polymerization catalyst feed (catalyst B and catalyst 2 from Table 1) to total catalyst feed is adjusted to maintain the desired split between the polymer soft segment and hard segment. The co-catalyst components (co-catalyst 3 and co-catalyst-4 from Table 1) are fed based on calculated specified molar ratios to the catalyst components. Immediately following each reactor feed injection location, the feed streams are mixed with the circulating polymerization reactor contents with static mixing elements. The contents of the reactor are continuously circulated through heat exchangers responsible for removing much of the heat of reaction and with the temperature of the coolant side responsible for maintaining an isothermal reaction environment at the specified temperature. Circulation around the reactor loop is provided by a pump.

The reactor effluent enters a zone where it is deactivated with the addition of and reaction with a suitable reagent (water). At this same reactor exit location other additives are added for polymer stabilization. Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process.

Polymerization conditions for comparative sample (CS) CS A and inventive example (IE) IE 1-7 are provided in Table 2 below.

TABLE 2
Polymerization conditions for CS A and IE 1-7

| | | CS A | IE 1 | IE 2 | IE 3 | IE 4 | IE 5 | IE 6 | IE 7 |
|---|---|---|---|---|---|---|---|---|---|
| Reactor Configuration | Type | Single | Single | Single | Single | Single | Single | Single | Single |
| Comonomer type | Type | 1-octene | 1-octene | 1-octene | 1-octene | 1-octene | 1-octene | 1-octene | 1-octene |
| Reactor Feed Solvent/ | g/g | 6.2 | 4.8 | 4.7 | 5.2 | 4.3 | 4.0 | 3.7 | 5.6 |
| Ethylene Mass Flow | | | | | | | | | |
| Ratio | | | | | | | | | |
| Reactor Feed | g/g | 2.45 | 1.90 | 1.89 | 1.52 | 1.83 | 1.57 | 2.74 | 3.18 |
| Comonomer/Ethylene | | | | | | | | | |
| Mass Flow Ratio | | | | | | | | | |
| Reactor Feed Hydrogen/ | g/g | 8.8E−05 | 5.9E−05 | 9.8E−05 | 3.2E−05 | 1.1E−04 | 7.3E−05 | 1.8E−05 | 3.8E−06 |
| Ethylene Mass Flow | | | | | | | | | |
| Ratio | | | | | | | | | |
| Reactor Zn/Ethylene | g/g | 3.78E−04 | 4.74E−04 | 6.68E−04 | 5.48E−04 | 9.36E−04 | 5.23E−04 | 8.02E−04 | 4.20E−04 |
| Mass Flow Ratio | | | | | | | | | |
| Reactor Temperature | ° C. | 125 | 150 | 150 | 150 | 150 | 150 | 150 | 140 |
| Reactor Pressure | barg | 36 | 38 | 38 | 38 | 38 | 38 | 36 | 36 |
| Reactor Ethylene | wt % | 87.4 | 88.1 | 88.6 | 84.2 | 89.4 | 88.9 | 89.5 | 86.3 |
| Conversion | | | | | | | | | |
| % of Total Catalyst Feed | Mole | 14.8 | 65.9 | 66.0 | 70.0 | 58.0 | 70.1 | 49.1 | 64.5 |
| from Catalyst 2 | % | | | | | | | | |
| Co-Catalyst 1 to Total | Ratio | 1.5 | 1.0 | 1.1 | 1.4 | 1.1 | 1.1 | 1.2 | 1.2 |
| Catalyst Molar Ratio (B | | | | | | | | | |
| to Metal) | | | | | | | | | |
| Co-Catalyst 2 Scavenger | Ratio | 2.5 | 8.4 | 7.1 | 14.3 | 13.1 | 15.6 | 8.0 | 13.9 |
| Molar Ratio (Al to Metal) | | | | | | | | | |
| Reactor Residence Time | min | 23.6 | 14.8 | 15.0 | 12.6 | 15.9 | 14.3 | 29.6 | 24.7 |

The polymerization conditions described above and shown in Table 2 produce ethylene/octene multi-block copolymers CS A and IE 1-7. The ethylene/octene multi-block copolymers CS A and IE 1-7 are subsequently compared to conventional ethylene/octene multi-block copolymer sold under the tradename INFUSE. Conventional ethylene/octene multi-block copolymers are provided in Table 3 below.

TABLE 3
Conventional ethylene/octene multi-block copolymer

| Material | Supplier | Description |
|---|---|---|
| CS B | Dow Chemical Co. | INFUSE ™ 9507, 0.866 g/cc, 5 MI |
| CS C | Dow Chemical Co. | INFUSE ™ 9010, 0.877 g/cc, 0.5 MI |
| CS D | Dow Chemical Co. | INFUSE ™ 9107, 0.866 g/cc, 1 MI |
| CS E | Dow Chemical Co. | D9130.05, 0.885 g/cc, 1.5 MI |
| CS F | Dow Chemical Co. | INFUSE ™ 9077, 0.869 g/cc, 0.5 MI |
| CS G | Dow Chemical Co. | INFUSE ™ 9817, 0.877 g/cc, 15 MI |

The properties of CS A and IE 1-7 from Table 2 and CS B-G from Table 3 are shown in Table 4 below.

TABLE 4
Properties of ethylene/octene multi-block copolymers

| | | | | | | | | | | | | | UYS | UYS | |
|---|---|---|---|---|---|---|---|---|---|---|---|---|---|---|---|
| | | | SS | | TGIC | NMR | | EOO | | | | | 1 mo | 2 mo | FF |
| | Density, | | Tm, | Tg, | Tₚ₂, | O | EOE/ | (OOE)/ | OOO/ | Total O/ | | Norm | 0° C./ | 0° C./ | 3 wks/ |
| Example | g/cc | I2 | ° C. | ° C. | ° C. | mol % | 1000C | 1000C | 1000C | 1000C | OOO% | OOO | 21° C. | 21° C. | 6 wks |
| CS A | 0.861 | 5.9 | −17.3 | −66.3 | 66.0 | 19.3 | 46.4 | 12.4 | 1.0 | 59.8 | 1.7 | 0.09 | | | |
| CS B | 0.869 | 5.3 | 11.2 | −61.3 | 82.4 | 16.2 | 43.2 | 9.2 | 0.6 | 53.0 | 1.1 | 0.07 | 288/12 | 256/31 | 138/151 |
| (9507) | | | | | | | | | | | | | | | |
| CS C | 0.877 | 0.5 | 27.9 | −56.3 | 101.4 | 10.7 | 34.5 | 4.5 | 0.6 | 39.6 | 1.5 | 0.14 | | | |
| (9010) | | | | | | | | | | | | | | | |
| CS D | 0.868 | 1.0 | 9.4 | −61.4 | 85.0 | 13.9 | 40.6 | 7.1 | 0.4 | 48.2 | 0.8 | 0.06 | 196/2 | 285/11 | 112/107 |
| (9107) | | | | | | | | | | | | | | | |
| CS E | 0.886 | 1.3 | 9.2 | −61.0 | 82.5 | 10.2 | 31.4 | 6.2 | 0.6 | 38.2 | 1.6 | 0.16 | | | |
| (9130.05) | | | | | | | | | | | | | | | |
| CSF | 0.877 | 0.5 | NA | −67.2 | 47.7 | 17.9 | 39.6 | 14.9 | 2.1 | 56.5 | 3.6 | 0.20 | | | |
| (9077) | | | | | | | | | | | | | | | |
| CS G | 0.882 | 18.3 | 7.3 | −62.2 | 82.5 | 12.7 | 37.7 | 7.6 | 0.4 | 45.7 | 0.8 | 0.07 | 1/0 | 2/0 | 219/200 |
| (9817) | | | | | | | | | | | | | | | |
| IE 1 | 0.866 | 1.1 | 8.0 | −62.8 | 78.1 | 17.1 | 33.9 | 17.6 | 3.6 | 55.1 | 6.5 | 0.40 | 32/0* | 53/0* | 144/190 |
| IE 2 | 0.866 | 5.8 | 6.8 | −63.0 | 75.1 | 16.6 | 34.0 | 17.5 | 3.1 | 54.6 | 5.7 | 0.35 | 53/0* | 72/2* | 158/152 |
| IE 3 | 0.878 | 0.5 | 27.5 | −57.8 | 95.8 | 12.2 | 29.3 | 11.0 | 1.7 | 42.0 | 4.0 | 0.36 | | | |
| IE 4 | 0.877 | 16.7 | 4.0 | −63.4 | 70.9 | 14.4 | 29.9 | 16.4 | 3.2 | 49.5 | 6.5 | 0.46 | 0/0* | 0/0* | 181/156 |
| IE 5 | 0.884 | 1.6 | 11.3 | −62.5 | 79.0 | 11.3 | 25.8 | 12.9 | 2.7 | 41.4 | 6.5 | 0.59 | | | |
| IE 6 | 0.860 | 5.3 | −16.2 | −66.2 | 62.1 | 22.5 | 35.7 | 24.2 | 6.4 | 66.3 | 9.7 | 0.44 | | | |
| IE 7 | 0.869 | 0.4 | −26.3 | −66.6 | 54.2 | 19.2 | 28.8 | 23.4 | 7.5 | 59.7 | 12.6 | 0.68 | | | |

FF—funnel flow measured at 3 weeks and 6 weeks (results reported in gram/seconds, g/s)
UYS—unconfined yield strength measured at 1 month and at 2 months at temperatures 0° C. and 21° C. (results reported in lb/ft²)
*for UYS test, talc contents are IE1: 3000 ppm, IE2/IE3 each 5000 ppm; INFUSE 9107/9507/9817 respective talc contents 3000/5000/5000 ppm

The ethylene/octene multi-block copolymers of IE 1, IE 2, IE 3, IE 4, IE 5, IE 6, and IE 7, have a higher overall octene content when compared to the ethylene/octene multi-block copolymers of comparative samples CS A, CS B, CS C, CS D, CS E, CS F, and CS G with the same design targets of density, MI and SS Tm. Typically polyethylene copolymers of the same density will have the same comonomer content. The ethylene/octene multi-block copolymers of IE 1-7 produced with Catalyst1/Catalyst2 system and polymerization conditions at a temperature greater than 125° C. (or a temperature from 130° C. to 150° C.) contain a different comonomer distribution along the polymer backbone which is evident in the EOE, EOO, and OOO sequences when comparing IE1-7 to comparative samples A-G. IE1 and CS D are similar in terms of density, MI and SS Tm. However, inventive example 1 exhibits over a 6× increase in normalized OOO triad content (0.40 normalized OOO triads) when compared to comparative sample D (0.06 normalized OOO triads).

IE2 and CS B are similar in terms of density and MI. However, inventive example 2 exhibits a 5× increase in normalized OOO triad content (0.35 normalized OOO triads) when compared to comparative sample B (0.07 normalized OOO triads).

IE3 and CS C are similar in terms of density, MI and SS Tm. However, inventive example 3 exhibits a 2× increase in normalized OOO triad content (0.36 normalized OOO triads) when compared to comparative sample C (0.14 normalized OOO triads).

IE4 and CS G are similar in terms of density, MI and SS Tm. However, inventive example 4 exhibits a 6× increase in normalized OOO triad content (0.46 normalized OOO triads) when compared to comparative sample G (0.07 normalized OOO triads).

IE5 and CS E are similar in terms of density, MI and SS Tm. However, inventive example 5 exhibits a 3× increase in normalized OOO triad content (0.59 normalized OOO triads) when compared to comparative sample E (0.16 normalized OOO triads).

IE6 and CS A are similar in terms of density, MI and SS Tm. However, inventive example 6 exhibits nearly a 5× increase in normalized OOO triad content (0.44 normalized OOO triads) when compared to comparative sample A (0.09 normalized OOO triads).

IE7 and CS F are similar in terms of density, MI and SS Tm. However, inventive example 7 exhibits a 3× increase in normalized OOO triad content (0.68 normalized OOO triads) when compared to comparative sample F (0.20 normalized OOO triads).

The higher overall octene content and increased likelihood that octene monomers would insert adjacent to each other was expected to result in poorer solids handling performance for the inventive examples when compared to the comparative samples—i.e., it was expected that the inventive examples would be more “sticky” compared to the comparative samples. However, Applicant discovered the ethylene/octene multi-block copolymers of IE1, IE2, and IE4 unexpectedly have improved solids handling when compared to conventional ethylene/octene multi-block copolymer similar in terms of density, MI and SS Tm. Table 4 shows IE1 has lower UYS and greater FF when compared to CS D. IE2 has lower UYS and greater FF when compared to CS B. IE4 has lower UYS when compared to CS G.

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
contacting ethylene and octene under polymerization conditions at a temperature greater than 125° C. with a catalyst system comprising
(i) a first polymerization catalyst having the structure of catalyst 1; 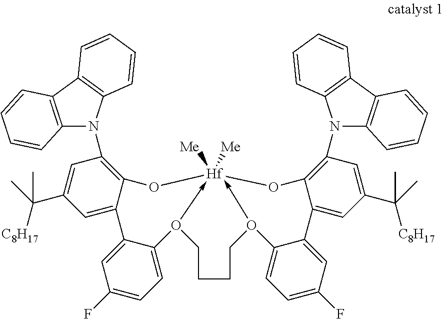
(ii) a second polymerization catalyst having the structure of catalyst 2; 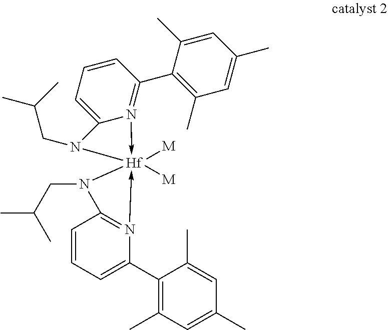
(iii) a first co-catalyst that is a borate-based co-catalyst;
(iv) a second co-catalyst that is an aluminum-based co-catalyst;
(v) a chain shuttling agent;
maintaining, during the contacting, an aluminum to hafnium molar ratio from 7.1 to 15.6; and
forming an ethylene/octene multi-block copolymer having a normalized OOO triad content greater than 0.25.

2. The process of claim 1 comprising contacting the ethylene and octene under polymerization conditions at a temperature from 130° C. to 170° C.; and
forming an ethylene/octene multi-block copolymer having hard segments and soft segments, the soft segments having a soft segment melting temperature (SS-Tm) from −30° C. to 30° C., the ethylene/octene multi-block copolymer having a first TGIC peak temperature (Tₚ₁) and a second TGIC peak temperature (Tₚ₂)
wherein Tₚ₂ fulfills Equation (A)
Tₚ₂≤0.0068×(SS-Tm)²+0.07×(SS-Tm)+73.2.

3. A composition comprising:
an ethylene/octene multi-block copolymer comprising hafnium and aluminum at an aluminum to hafnium molar ratio from 7.1 to 15.6; and
the ethylene/octene multi-block copolymer has a normalized OOO triad content greater than 0.25.

4. The composition of claim 3 wherein the ethylene/octene multi-block copolymer comprises from 10 mol % to 30 mol % of octene.

5. The composition of claim 4 wherein
the ethylene/octene multi-block copolymer comprises hard segments and soft segments, the soft segments having a soft segment melting temperature (SS-Tm) from −30° C. to 30° C., the ethylene/octene multi-block copolymer having a first TGIC peak temperature (Tₚ₁) and a second TGIC peak temperature (Tₚ₂)
wherein Tₚ₂ fulfills Equation (A)
Tₚ₂≤0.0068×(SS-Tm)²+0.07×(SS-Tm)+73.2.

6. The composition of claim 5 wherein the ethylene/octene multi-block copolymer has Tₚ₁ from 125° C. to 150° C. and a Tₚ₂ from 68° C. to 90° C.

7. The composition of claim 6 wherein the ethylene/octene multi-block copolymer has a glass transition temperature (Tg) from −70° C. to −55° C.

8. The composition of claim 7 wherein the ethylene/octene multi-block copolymer has a density from 0.855 to 0.890 grams per cubic centimeter (g/cc).

9. The composition of claim 8 wherein the ethylene/octene multi-block copolymer has an unconfined yield strength (UYS) from 0 lb/ft² to less than 200 lb/ft² at 21° C. after two months.

10. The composition of claim 9 wherein the ethylene/octene multi-block copolymer has a funnel flow from greater than 150 g/s to 200 g/s after 6 weeks.

11. The composition of claim 10 wherein the ethylene/octene multi-block copolymer has an unconfined yield strength (UYS) from 0 lb/ft² to less than 73 lb/ft² at 0° C. after two months.
